(19) United States
(12) Patent Application Publication
(10) Pub. No.: US 2012/0038752 A1
(43) Pub. Date: Feb. 16, 2012

(54) IMAGE DISPLAY DEVICE

(76) Inventor: Wookyu SANG, Gyeonggi-do (KR)

(21) Appl. No.: 12/963,795

(22) Filed: Dec. 9, 2010

(30) Foreign Application Priority Data
Aug. 12, 2010 (KR) 10-2010-0077672

(51) Int. Cl. H04N 13/04

(52) U.S. Cl. 348/51; 348/E13.075

(57) ABSTRACT

An image display device comprises a display panel selectively displaying a 2D image and a 3D image according to a mode selection signal; a first memory enabled in a 2D mode to output a previously stored first compensation value; a second memory enabled in a 3D mode to output a previously stored second compensation value; and a timing controller modulating input digital video data based on the first compensation value to display the 2D image in the 2D mode and modulating input digital video data based on the second compensation value to display the 3D image in the 3D mode.

This application claims the benefit of Korea Patent Application No. 10-2010-0077672 filed on Aug. 12, 2010, which is incorporated herein by reference for all purposes as if fully set forth herein.

### BACKGROUND

1. Field

This document relates to an image display device capable of improving picture quality.

2. Related Art

With the advancement of various image processing techniques, image display systems capable of selectively displaying 2D images 3D images are developed.

Methods of generating 3D images are divided into a stereoscopic technique and an autostereoscopic technique. The stereoscopic technique uses disparity images of left and right eyes, which have high 3D effect, and includes a stereoscopic method and an autostereoscopic method which are practically used. The autostereoscopic method provides an optical plate such as a parallax barrier for separating optical axes of left and right disparity images from each other before or behind a display screen. The stereoscopic method displays left and right disparity images having different polarization directions on a liquid crystal display panel and generates 3D images by using polarizing glasses or liquid crystal shutter glasses.

An image display device may include a liquid crystal display (LCD) as a display element. The LCD, a hold type display device, holds data charged in a previous frame right before new data is written because of maintenance characteristic of liquid crystal. The response time of liquid crystal is delayed according to data writing. The response delay of liquid crystal causes image blurring, and thus motion blurring is generated when a 2D image is displayed through the image display device and 3D crosstalk in the form of a ghost is generated when a 3D image is displayed through the image display device.

Various methods for improving the response characteristic of liquid crystal are known. Over driving control (ODC) compares previous frame data and current frame data to each other and modulates input data according to a compensation value predetermined based on a data variation between a current frame and a previous frame. Referring to FIG. 1, the ODC modulates the current frame data into “223” larger than “191” when the previous frame data is “127” and the current frame data is “191” and modulates the current frame data into “31” smaller than “63” when the previous frame data is “191” and the current frame data is “63” so as to increase the response time of liquid crystal. Here, “223” and “31” denote ODC compensation values.

The ODC compensation values are predetermined through experiments and stored in an electrically erasable programmable read only memory (EEPROM) 2 as shown in FIG. 2. A timing controller 1 of the image display device reads compensation data stored in the EEPROM 2 when a driving voltage is applied to the image display device. The communication protocol between the timing controller 1 and the EEPROM 2 is designed according to communication standard protocol such as I2C for serial data communication. The compensation data is serial data SDA and is synchronized with a serial clock signal SCL and transmitted to the timing controller 1.

However, a conventional image display device is designed such that the image display device includes only a single EEPROM, and thus an ODC compensation value read from the EEPROM in a 2D mode for displaying 2D images is identical to an ODC compensation value read from the EEPROM in a 3D mode for displaying 3D images. Operating-level signals are inputted to address terminals and a power input terminal of the EEPROM irrespective of whether the image display device is in the 2D mode or in the 3D mode.

To obtain the best picture quality in the 2D mode and the 3D mode, the ODC compensation value read from the EEPROM in the 2D mode is required to be different from the ODC compensation value read from the EEPROM in the 3D mode. To achieve this, it is required to use multiple EEPROMs and to set different ODC compensation values for different driving modes.

### SUMMARY

An aspect of this document is to provide an image display device capable of achieving the best picture quality by using multiple EEPROMs.

In an aspect, an image display device comprises a display panel selectively displaying a 2D image and a 3D image according to a mode selection signal; a first memory enabled in a 2D mode to output a previously stored first compensation value; a second memory enabled in a 3D mode to output a previously stored second compensation value; and a timing controller modulating input digital video data based on the first compensation value to display the 2D image in the 2D mode and modulating input digital video data based on the second compensation value to display the 3D image in the 3D mode.

The image display device may further comprise a signal inverter for inverting the mode selection signal, wherein the mode selection signal is applied to one of the first and second memories and the inverted signal of the mode selection signal is applied to the other from the signal inverter.

The mode selection signal may correspond to a low level in the 2D mode and correspond to a high level in the 3D mode.

The second memory may be disabled when the first memory is enabled and enabled when the first memory is disabled.

The first memory may comprise a power terminal connected to a high-level source voltage input terminal; a first address terminal connected to a low-level source voltage input terminal; and second and third address terminals connected to a mode selection signal input terminal.

The second memory may comprise a power terminal connected to the high-level source voltage input terminal; a first address terminal connected to the low-level source voltage input terminal; and second and third address terminals connected to an output terminal of the signal inverter to receive the inverted signal of the mode selection signal.

The first and second memories may be disabled when the signals applied to the second and third terminals of the first and second memories correspond to a high level and enabled when the signals applied to the second and third terminals of the first and second memories correspond to a low level.

The first memory may comprise a power terminal connected to the output terminal of the signal inverter to receive the inverted signal of the mode selection signal as a first source voltage and first, second and third address terminals commonly connected to the low-level source voltage input terminal.

The second memory may comprise a power terminal connected to the mode selection signal input terminal to receive the mode selection signal as a second source voltage and first, second and third address terminals commonly connected to the low-level source voltage input terminal.

The first and second memories may be enabled when the first and second source voltages correspond to a high level and disabled when the first and second source voltages correspond to a low level.

### BRIEF DESCRIPTION OF THE DRAWINGS

The implementation of this document will be described in detail with reference to the following drawings in which like numerals refer to like elements.

FIG. 1 is a view for explaining a conventional over driving control (ODC) method;

FIG. 2 illustrates a memory of a conventional image display device;

FIG. 3 is a block diagram of an implementation of an image display device;

FIGS. 4, 5 and 6 illustrate exemplary configuration and operation of a memory circuit for selectively enabling first and second memories according to a mode selection signal; and

FIGS. 7, 8 and 9 illustrate another exemplary configuration and operation of the memory circuit for selectively enabling the first and second memories according to the mode selection signal.

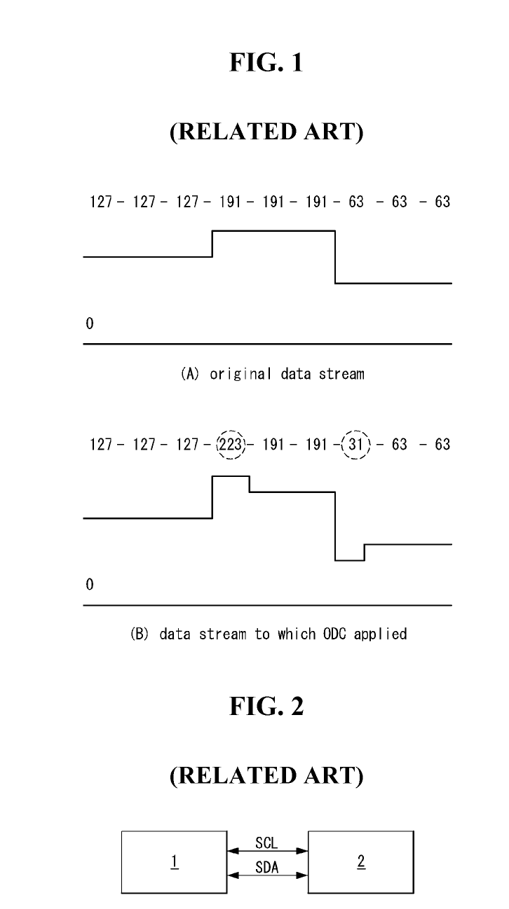

### DETAILED DESCRIPTION

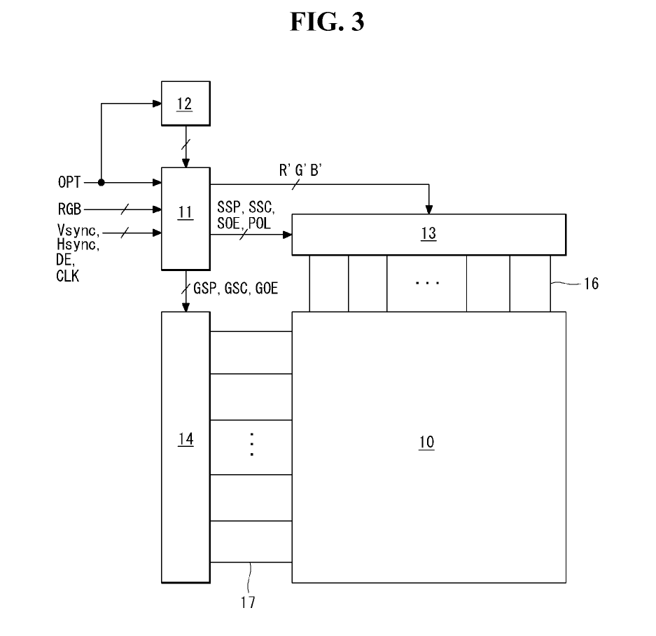

Hereinafter, an implementation of this document will be described in detail with reference to FIGS. 3 through 9.

FIG. 3 is a block diagram of an implementation of an image display device.

The image display device may include one of flat panel displays such as a liquid crystal display (LCD), a field emission display (FED), a plasma display panel (PDP), an organic light emitting diode (OLED), and an electrophoresis display (EPD) as a display for selectively displaying 2D and 3D images. The following description is given under the assumption that the image display device includes the LCD as a display.

Referring to FIG. 3, the image display device includes an LCD panel 10, a timing controller 11, a memory circuit 12, a data driving circuit 13, and a gate driving circuit 14.

The LCD panel 10 includes liquid crystal molecules interposed between two glass substrates. The LCD panel 10 has liquid crystal cells arranged in a matrix form according to an intersecting structure of data lines 16 and gate lines 17.

A pixel array including the data lines 16, the gate lines 17, thin film transistors (TFTs), pixel electrodes of the liquid crystal cells connected to the TFTs, and a storage capacitor is formed on the lower glass substrate of the LCD panel 10.

A black matrix, a color filter, and a common electrode are formed on the upper glass substrate of the LCD panel 10. The common electrode is formed on the upper glass substrate in a vertical field driving mode such as a twisted nematic (TN) mode and a vertical alignment (VA) mode and formed together with the pixel electrodes on the lower glass substrate in a horizontal field driving mode such as an in-plane switching (IPS) mode and a fringe field switching (FFS) mode.

Polarizers having optical axes perpendicular to each other are respectively attached to the upper and lower glass substrates of the LCD panel 10 and an alignment film for setting a pretilt angle of liquid crystal is formed on the inner sides of the upper and lower glass substrates, which come into contact with the liquid crystal.

The LCD panel 10 may operate in any mode in addition to the TN mode, VA mode, IPS mode, FFS mode. The LCD according to the present invention may be of transmission type, transflective type or reflective type. Transmission type and transflective type LCDs require a back light unit. The back light unit may be a direct type back light unit or an edge type back light unit.

The data driving circuit 13 has source drive ICs each including a shift register, a latch, a digital-to-analog converter (DAC), and an output buffer. The data driving circuit 13 latches modulated digital video data R′G′B′ under the control of the timing controller 11. The data driving circuit 13 converts the modulated digital video data R′G′B′ into a positive gamma compensation voltage and a negative gamma compensation voltage to invert the polarity of a data voltage in response to a polarity control signal POL. The data driving circuit 13 outputs the data voltage in synchronization with a gate pulse signal to the data lines 16. The source drive ICs of the data driving circuit 13 may be mounted on a tape carrier package (TCP) and bonded to the lower glass substrate of the LCD panel 10 through a tape automated bonding (TAB) process.

The data driving circuit 13 outputs data voltages of a 2D image having no left-eye and right-eye images in the 2D mode. The data driving circuit 13 spatially or temporally separates data voltages of left-eye and right-eye images from each other and provides the separated data voltages to the data lines 16 in the 3D mode.

The gate driving circuit 14 includes a shift register, a multiplexer array, and a level shifter. The gate driving circuit 14 sequentially provides the gate pulse signal (or scan pulse signal) to the gate lines 17 under the control of the timing controller 11. The gate driving circuit 14 may be mounted on a TCP and bonded to the lower glass substrate of the LCD panel 10 through a TAB process. Otherwise, the gate driving circuit 14 may be directly formed on the lower glass substrate together with the pixel array through a gate in panel (GIP) process.

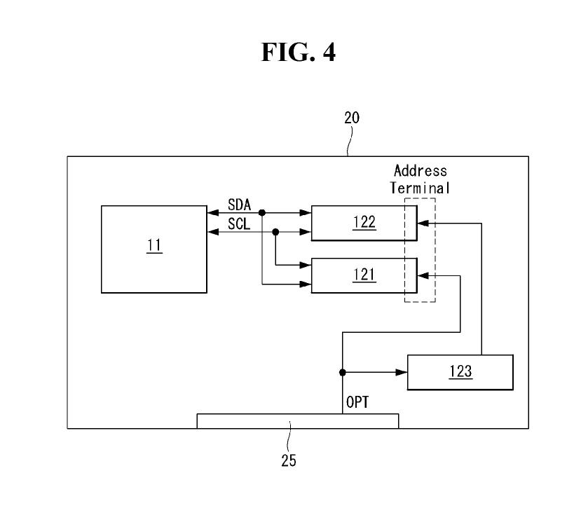

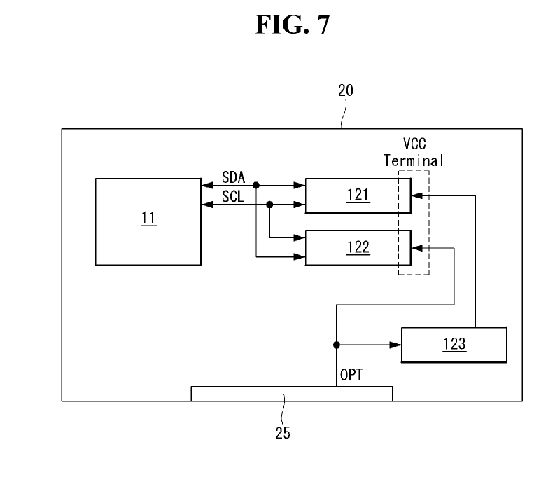

The memory circuit 12 includes two memories 121 and 122 selectively enabled according to a mode selection signal OPT inputted from a system board (not shown), as shown in FIGS. 4 and 7. The memories 121 and 122 may be EEPROMs or extended display identification data ROMs (EDID ROMs) which can update or erase data. The mode selection signal OPT may be applied to the system board through a user interface (not shown). The user interface may include a touch screen attached onto or included in the LCD panel 10, an on-screen display (OSD), a keyboard, a mouse, and a remote controller. The first memory 121 is enabled in the 2D mode and stores a first compensation value. The second memory 122 is enabled in the 3D mode and stores a second compensation value. The first and second compensation values are previously determined through experiments to achieve the best picture quality in the 2D and 3D modes. The first and second compensation values may be ODC compensation values in the 2D and 3D modes. However, the first and second compensation values are not limited to the ODC compensation values and may be any data that is added to or subtracted from original data or replaces the original data for enhancing picture quality. The first and second compensation values may be different from each other. Configurations for selectively enabling the first and second memories 121 and 122 according to the mode selection signal OPT will be explained below in detail with reference to FIGS. 4 through 9.

The timing controller 11 receives 2D/3D digital video signal RGB, the mode selection signal OPT, a vertical synchronization signal Vsync, a horizontal synchronization signal Hsync, a data enable signal DE, and a dot clock signal CLK from the system board. The timing controller 11 generates a data timing control signal for controlling the operating timing of the data driving circuit 13 and a gate timing control signal for controlling the operating timing of the gate driving circuit 14 based on timing signals. The timing controller 11 may receive the mode selection signal OPT from the system board to check whether the image display device in the 2D mode or in the 3D mode.

The timing controller 11 may modulate the 2D digital video data RGB based on the first compensation value read from the first memory 121 to generate modulated 2D video data R′G′B′ corresponding to a 2D image and transmit the modulated 2D video data R′G′B′ to the data driving circuit 13 at an input frame frequency or a frame frequency corresponding to the input frame frequency×i Hz (i is a positive integer greater than 2) in the 2D mode. The timing controller 11 may modulate the 3D digital video data based on the second compensation value read from the second memory 122 to generate modulated 3D video data R′G′B′ corresponding to a 3D image and transmit the modulated 3D video data R′G′B′ to the data driving circuit 13 at a frame frequency corresponding to the input frame frequency×i Hz (i is a positive integer greater than 2) in the 3D mode. Here, the input frame frequency is 60 Hz in NTSC (National Television Standards Committee) mode and 50 Hz in PAL (Phase-Alternating Line) mode.

The data timing control signal includes a source start pulse signal SSP, a source sampling clock signal SSC, a polarity control signal (POL), and a source output enable signal SOE. The source start pulse signal SSP controls data sampling start timing of the data driving circuit 13. The source sampling clock signal SSC controls the sampling timing of data in the data driving circuit 13 on the basis of a rising edge or a falling edge. The polarity control signal POL controls the polarity of a data voltage output from the data driving circuit 13. The source output enable signal SOE controls the output timing of the data driving circuit 13. If digital video data inputted to the data driving circuit 13 is transmitted through mini LVDS (Low Voltage Differential Signaling) interface, the source start pulse signal SSP and the source sampling clock signal SSC may be omitted.

The gate timing control signal includes a gate start pulse signal GSP, a gate shift clock signal GSC, and a gate output enable signal GOE. The gate start pulse signal GSP generates the first output of the gate driving circuit 14. The gate shift clock signal GSC shifts the gate start pulse signal GSP. The gate output enable signal GOE controls output of the gate driving circuit 14.

FIGS. 4, 5 and 6 illustrate exemplary configuration and operation of the memory circuit 12 for selectively enabling the first and second memories 121 and 122 according to the mode selection signal OPT.

The memory circuit 12 is mounted on a control PCB (Printed Circuit Board) 20 with the timing controller 11, as shown in FIG. 4. The control PCB 20 includes a user connector 25 and receives the mode selection signal OPT from the system board through the user connector 25. The memory circuit 12 further includes a signal inverter 123 for inverting the mode selection signal OPT. Whether the first memory 121 is enabled is controlled according to the mode selection signal OPT inputted to address terminals of the first memory 121 from the user connector 25. Whether the second memory 122 is enabled is controlled according to an inverted signal of the mode selection signal OPT, which is inputted to address terminals of the second memory 122 from signal inverter 123. The second memory 122 is disabled when the first memory 121 is enabled and enabled when the first memory 121 is disabled.

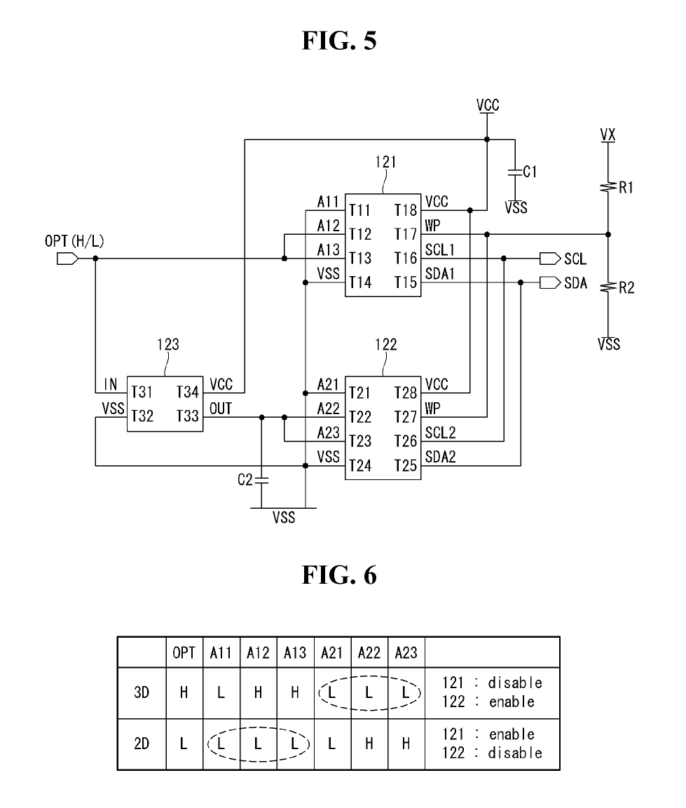

FIG. 5 illustrates configurations of the first and second memories 121 and 122 and the signal inverter 123.

Referring to FIG. 5, the first memory 121 selectively outputting the first compensation value includes first through eighth terminals T11 through T18. The first, second and third terminals T11, T12 and T13 are address terminals to which first, second and third address signals A11, A12 and A13 are respectively applied. The fourth terminal T14 receives a low level (for example, 0V) source voltage VSS and the eighth terminal T18 receives a high level (for example, 3.3V) source voltage VCC. The fifth terminal T15 outputs the first compensation value as first serial data SDA1 and the sixth terminal T16 outputs a first serial clock signal SCL1 in synchronization with the first compensation value. The seventh terminal T17 is a writing protection terminal WP.

The first terminal T11 is connected to a low-level source voltage VSS input terminal and the second and third terminals T12 and T13 are connected to a mode selection signal OPT input terminal. The low-level source voltage VSS is applied to the first terminal T11 as the first address signal A11 and the mode selection signal OPT is applied to the second and third terminals T12 and T13 as the second and third address signals A12 and A13.

The second memory 122 selectively outputting the second compensation value includes first through eighth terminals T21 through T28. The first, second and third terminals T21, T22 and T23 are address terminals to which first, second and third address signals A21, A22 and A23 are respectively applied. The fourth terminal T24 receives the low-level source voltage VSS and the eighth terminal T28 receives the high-level source voltage VCC. The fifth terminal T25 outputs the second compensation value as second serial data SDA2 and the sixth terminal T26 outputs a second serial clock signal SCL2 in synchronization with the second compensation value. The seventh terminal T27 corresponds to a writing protection terminal WP.

The first terminal T21 is connected to the low-level source voltage VSS input terminal and the second and third terminals T22 and T23 are connected to an output terminal T33 of the signal inverter 123. The low-level source voltage VSS is applied to the first terminal T21 as the first address signal A21 and the inverted signal of the mode selection signal OPT is applied to the second and third terminals T22 and T23 as the second and third address signals A22 and A23.

The signal inverter 123 inverting the mode selection signal OPT includes first, second, third and fourth terminals T31, T32, T33 and T34. The first terminal T31 is an input terminal to which the mode selection signal OPT is inputted and the second terminal T32 is an input terminal to which the low-level source voltage VSS is applied. The third terminal T33 outputs the inverted signal of the mode selection signal OPT and the fourth terminal T34 receives the high-level source voltage VCC.

First and second resistors R1 and R2 divide a control source voltage VX, and the divided voltage is applied to the seventh terminals T17 and T27 of the first and second memories 121 and 122. Data writing to the first and second memories 121 and 122 is prevented when the control source voltage VX is controlled to a high level and data writing to the first and second memories 121 and 122 is allowed when the control source voltage VX is controlled to a low level. A first capacitor C1 is connected to a high-level source voltage VCC input terminal to stabilize the source voltage VCC. A second capacitor C2 is connected to the output terminal T33 of the signal inverter 123 to remove ripples included in the inverted signal of the mode selection signal OPT.

The operations of the first and second memories 121 and 122 and the signal inverter 123 will now be explained with reference to FIG. 6.

The mode selection signal OPT corresponds to a high level in the 3D mode and corresponds to a low level in the 2D mode. The first memory 121 is enabled when the high-level source voltage VCC is inputted to the eighth terminal T18 and the low-level first, second and third address signals A11, A12 and A13 are respectively applied to the first, second and third terminals T11, T12 and T13. The second memory 122 is enabled when the high-level source voltage VCC is inputted to the eighth terminal T28 and the low-level first, second and third address signals A21, A22 and A23 are respectively applied to the first, second and third terminals T21, T22 and T23.

In the 3D mode, the first memory 121 is disabled by the high-level mode selection signal OPT inputted to the second and third terminals T12 and T13 and the second memory 122 is enabled by the inverted signal (low level) of the mode selection signal OPT applied to the second and third terminals T22 and T23. Accordingly, the second memory 122 is selected and the second compensation value stored in the second memory 122 is output to the timing controller 11.

In the 2D mode, the first memory 121 is enabled by the low-level mode selection signal OPT inputted to the second and third terminals T12 and T13 and the second memory 122 is disabled by the inverted signal (high level) of the mode selection signal OPT applied to the second and third terminals T22 and T23. Accordingly, the first memory 121 is selected and the first compensation value stored in the first memory 121 is output to the timing controller 11.

FIGS. 7, 8 and 9 illustrate another exemplary configuration and operation of the memory circuit 12 for selectively enabling the first and second memories 121 and 122 according to the mode selection signal OPT.

The memory circuit 12 is mounted on the control PCB 20 with the timing controller 11, as shown in FIG. 7. The control PCB 20 includes the user connector 25 and receives the mode selection signal OPT from the system board through the user connector 25. The memory circuit 12 further includes a signal inverter 123 for inverting the mode selection signal OPT. Whether the second memory 122 is enabled is controlled according to the mode selection signal OPT inputted to a power terminal of the second memory 122 from the user connector 25. Whether the first memory 121 is enabled is controlled according to an inverted signal of the mode selection signal OPT, which is inputted to a power terminal of the first memory 121 from signal inverter 123. The second memory 122 is disabled when the first memory 121 is enabled and enabled when the first memory 121 is disabled.

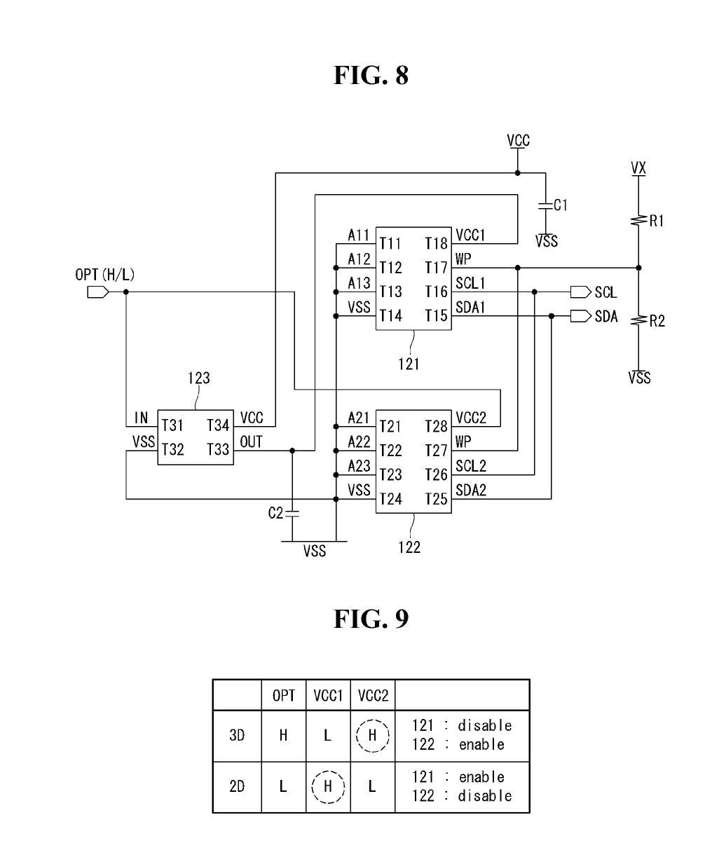

FIG. 8 illustrates configurations of the first and second memories 121 and 122 and the signal inverter 123.

Referring to FIG. 8, the first memory 121 selectively outputting the first compensation value includes first through eighth terminals T11 through T18. The first, second and third terminals T11, T12 and T13 are address terminals to which first, second and third address signals A11, A12 and A13 are respectively applied. The fourth terminal T14 receives a low level (for example, 0V) source voltage VSS and the fifth terminal T15 outputs the first compensation value as first serial data SDA1. The sixth terminal T16 outputs a first serial clock signal SCL1 in synchronization with the first compensation value and the seventh terminal T17 is a writing protection terminal WP. The eighth terminal T18 receives a first source voltage VCC1 through the signal inverter 123.

The first, second and third terminals T11, T12 and T13 are connected to a low-level source voltage VSS input terminal. The low-level source voltage VSS is applied to the first, second and third terminals T11, T12 and T13 as the first address signals A11, A12 and A13. The eighth terminal T18 is connected to the output terminal T33 of the signal inverter 123. The inverted signal of the mode selection signal OPT is applied to the eighth terminal T18 as the first source voltage VCC1.

The second memory 122 selectively outputting the second compensation value includes first through eight terminals T21 through T28. The first, second and third terminals T21, T22 and T23 are address terminals to which first, second and third address signals A21, A22 and A23 are respectively applied. The fourth terminal T24 receives the low-level source voltage VSS and the fifth terminal T25 outputs the second compensation value as second serial data SDA2. The sixth terminal T26 outputs a second serial clock signal SCL2 in synchronization with the second compensation value and the seventh terminal T27 corresponds to a writing protection terminal WP. The eighth terminal T28 receives the mode selection signal OPT as a second source voltage VCC2.

The first, second and third terminals T21, T22 and T23 are connected to the low-level source voltage VSS input terminal. The low-level source voltage VSS is applied to the first, second and third terminals T21, T22 and T23 as the first, second and third address signals A21, A22 and A23. The eighth terminal T28 is connected to a mode selection signal OPT input terminal. The mode selection signal OPT is applied to the eighth terminal T28 as the second source voltage VCC2.

The signal inverter 123 inverting the mode selection signal OPT includes first, second, third and fourth terminals T31, T32, T33 and T34. The first terminal T31 is an input terminal to which the mode selection signal OPT is inputted and the second terminal T32 is an input terminal to which the low-level source voltage VSS is applied. The third terminal T33 outputs the inverted signal of the mode selection signal OPT and the fourth terminal T34 receives the high-level source voltage VCC.

First and second resistors T1 and R2 divide a control source voltage VX, and the divided voltage is applied to the seventh terminals T17 and T27 of the first and second memories 121 and 122. Data writing to the first and second memories 121 and 122 is prevented when the control source voltage VX is controlled to a high level and data writing to the first and second memories 121 and 122 is allowed when the control source voltage VX is controlled to a low level. A first capacitor C1 is connected to a high-level source voltage VCC input terminal to stabilize the source voltage VCC. A second capacitor C2 is connected to the output terminal T33 of the signal inverter 123 to remove ripples included in the inverted signal of the mode selection signal OPT.

The operations of the first and second memories 121 and 122 and the signal inverter 123 will now be explained with reference to FIG. 9.

The mode selection signal OPT corresponds to a high level in the 3D mode and corresponds to a low level in the 2D mode. The first memory 121 is enabled when the first source voltage VCC1 inputted to the eighth terminal T18 is a high level and the low-level first, second and third address signals A11, A12 and A13 are respectively applied to the first, second and third terminals T11, T12 and T13. The second memory 122 is enabled when the second source voltage VCC2 inputted to the eighth terminal T28 is a high level and the low-level first, second and third address signals A21, A22 and A23 are respectively applied to the first, second and third terminals T21, T22 and T23.

In the 3D mode, the first memory 121 is disabled by the inverted signal (low level) of the mode selection signal OPT, applied to the eighth terminal T18, and the second memory 122 is enabled by the high-level mode selection signal OPT applied to the eighth terminal T28. Accordingly, the second memory 122 is selected and the second compensation value stored in the second memory 122 is output to the timing controller 11.

In the 2D mode, the first memory 121 is enabled by the inverted signal (high level) of the mode selection signal OPT, applied to the eighth terminal T18, and the second memory 122 is disabled by the low-level mode selection signal OPT applied to the eighth terminal T28. Accordingly, the first memory 121 is selected and the first compensation value stored in the first memory 121 is output to the timing controller 11.

As described above, the image display device according to the present invention can achieve the best picture quality in the 2D and 3D modes by using multiple EEPROMs.

Other implementations are within the scope of the following claims.

What is claimed is:

1. An image display device comprising:
a display panel selectively displaying a 2D image and a 3D image according to a mode selection signal;
a first memory enabled in a 2D mode to output a first compensation value;
a second memory enabled in a 3D mode to output a second compensation value; and
a timing controller modulating input video data based on the first compensation value to display the 2D image in the 2D mode and modulating input video data based on the second compensation value to display the 3D image in the 3D mode.

2. The image display device of claim 1, wherein the mode selection signal corresponds to a low level in the 2D mode and corresponds to a high level in the 3D mode.

3. The image display device of claim 1, further comprising a signal inverter for inverting the mode selection signal, wherein the mode selection signal is applied to one of the first and second memories and an inverted signal of the mode selection signal is applied to the other one of the first and second memories from the signal inverter.

4. The image display device of claim 3, wherein the signal inverter comprises:
a first terminal to which the mode selection signal is inputted;
a second terminal to which a low-level source voltage is applied;
a third terminal outputting the inverted signal of the mode selection signal; and
a fourth terminal receiving a high-level source voltage.

5. The image display device of claim 3, wherein the second memory is disabled when the first memory is enabled and enabled when the first memory is disabled.

6. The image display device of claim 5, wherein whether the first memory is enabled is controlled according to the mode selection signal inputted to the first memory, whether the second memory is enabled is controlled according to the inverted signal of the mode selection signal which is inputted to the second memory from the signal inverter.

7. The image display device of claim 3, wherein the first memory comprises:
a first address terminal connected to a low-level source voltage input terminal;
second and third address terminals connected to a mode selection signal input terminal to receive the mode selection signal; and
a power terminal receiving a high-level source voltage.

8. The image display device of claim 7, wherein the second memory comprises:
a first address terminal connected to the low-level source voltage input terminal;
second and third address terminals connected to an output terminal of the signal inverter to receive the inverted signal of the mode selection signal; and
a power terminal receiving the high-level source voltage.

9. The image display device of claim 8, wherein the first and second memories are disabled when the signals applied to the second and third terminals of the first and second memories correspond to a high level and enabled when the signals applied to the second and third terminals of the first and second memories correspond to a low level.

10. The image display device of claim 5, wherein whether the second memory is enabled is controlled according to the mode selection signal inputted to the second memory, whether the first memory is enabled is controlled according to the inverted signal of the mode selection signal which is inputted to the first memory from the signal inverter.

11. The image display device of claim 3, wherein the first memory comprises:
first, second and third address terminals commonly connected to the low-level source voltage input terminal; and
a power terminal connected to the output terminal of the signal inverter to receive the inverted signal of the mode selection signal as a first source voltage.

12. The image display device of claim 11, wherein the second memory comprises:
first, second and third address terminals commonly connected to the low-level source voltage input terminal; and
a power terminal connected to the mode selection signal input terminal to receive the mode selection signal as a second source voltage.

13. The image display device of claim 12, wherein the first and second memories are enabled when the first and second source voltages correspond to a high level and disabled when the first and second source voltages correspond to a low level.
